(19) United States
(12) Patent Application Publication
(10) Pub. No.: US 2025/0130620 A1
(43) Pub. Date: Apr. 24, 2025

(54) SOC FAULT INDICATION STRATEGY TO THE MCU FOR THE ADAPTIVE PARTITIONS DURING BOOTUP STAGE

(71) Applicant: FCA US LLC, Auburn Hills, MI (US)

(72) Inventors: Vinoot Handiganoor, Bangalore (IN); Basavana Gowda B, Bangalore (IN)

(21) Appl. No.: 18/633,841

(22) Filed: Apr. 12, 2024

Related U.S. Application Data
(60) Provisional application No. 63/592,222, filed on Oct. 23, 2023.

(51) Int. Cl. G06F 1/3212; G06F 1/3234; G06F 1/3293

(52) U.S. Cl. CPC G06F 1/3212; G06F 1/3243; G06F 1/3293

(57) ABSTRACT

A microcontroller unit (MCU) is configured to provide the command to a power management integrated circuit (PMIC) to power up or reset a system-on-chip (SoC) and to handle errors and statuses of an SoC bootup phase by commanding the PMIC to power up the SoC, monitoring for a first response from the primary bootloader indicating the bootup phase was successful, commanding the PMIC to reset the SoC when the first response is not received from the primary bootloader within a first timeout period, selectively requesting the secondary bootloader to switch from a first partition to a second partition for the bootup phase, and after resetting the SoC, completing the bootup phase using the secondary bootloader and the first or second partition.

### CROSS-REFERENCE TO RELATED APPLICATION(S)

The present application claims the benefit of U.S. Provisional Application No. 63/592,222, filed on Oct. 23, 2023. The disclosure of the above-identified application is incorporated herein by reference in its entirety.

### FIELD

The present application generally relates to vehicle control systems and, more particularly, to techniques for failure state handling and recovery during system-on-chip (SoC) bootup processes.

### BACKGROUND

Today's vehicles include a plurality of different electronic control units (ECUs) each configured to perform control different aspects of vehicle operation. One architecture for a vehicle control system is a zonal architecture, in which a central microcontroller control unit (MCU) is configured to oversee a plurality of different system-on-chips (SoCs) associated with a particular zone of the vehicle. Each SoC is an integrated circuit (IC) that includes, for example, one or more processors or processor cores, memory, input/output (IO) devices, and networking components. Each SoC performs a bootup phase upon power up and reset, such as after software or firmware upgrades. In some cases, such as unauthorized software upgrades, SoC bootup failures occur, which could cause a larger portion of the vehicle control system to begin behaving improperly. This is increasingly true with the advancement of over-the-air (OTA) update capabilities. Conventional solutions for SoC bootup failure handling include built-in self-tests (BISTs), watchdog timers, and interrupts, but these solutions are limited to a specific set of failure states and also do not provide adequate recovery methods after an SoC bootup failure (e.g., long debugging processes). Accordingly, while such conventional vehicle control systems do work for their intended purpose, there exists an opportunity for improvement in the relevant art.

### SUMMARY

According to one example aspect of the invention, a control system for a vehicle is presented. In one exemplary implementation, the control system comprises a system-on-chip (SoC) configured to execute an application after performing a bootup phase via at least one of a primary bootloader and a secondary bootloader, a power management integrated circuit (PMIC) configured to, in response to a command, control an output of a supply power to the SoC to power up or reset the SoC, and a microcontroller unit (MCU) configured to provide the command to the PMIC to power up or reset the SoC and to handle errors and statuses of the SoC bootup phase by commanding the PMIC to power up the SoC, monitoring for a first response from the primary bootloader indicating the bootup phase was successful, commanding the PMIC to reset the SoC when the first response is not received from the primary bootloader within a first timeout period, selectively requesting the secondary bootloader to switch from a first partition to a second partition for the bootup phase, and after resetting the SoC, completing the bootup phase using the secondary bootloader and the first or second partition.

In some implementations, the MCU is further configured to handle the errors and statuses of the SoC bootup phase by monitoring for a second response from the secondary bootloader indicating that the bootup phase was successful and requesting the secondary bootloader to switch from the first partition to the second partition when the second response is not received from the secondary bootloader within a second timeout period. In some implementations, the MCU is further configured to handle the errors and statuses of the SoC bootup phase by monitoring for a third response from the application indicating that the bootup phase was successful and requesting the secondary bootloader to switch from the first partition to the second partition when the third response is not received from the application within a third timeout period. In some implementations, the MCU is further configured to handle the errors and statuses of the SoC bootup phase by setting a diagnostic trouble code (DTC) in response to a timeout of any of the first, second, and third timeout periods. In some implementations, the first timeout period is approximately 60 to 80 milliseconds (ms), the second timeout period is approximately 100 ms, and the third timeout period is approximately 150 ms.

In some implementations, the MCU is configured to request the secondary bootloader to switch from the first partition to the second partition based on an adaptive partition switch setting of a set of general purpose input/output (GPIO) output pins of the MCU. In some implementations, the primary bootloader is provided by a supplier of the SoC and is not configurable by an original equipment manufacturer (OEM) of the vehicle. In some implementations, the control system has a zonal architecture, and wherein the SoC, the PMIC, and the MCU are all part of a same zone of the zonal architecture. In some implementations, the same zone includes the SoC and one or more other SoCs that are all associated with the MCU.

According to another example aspect of the invention, a method of handling errors and statuses of a bootup phase of an SoC of a control system of a vehicle is presented. In one exemplary implementation, the method comprises commanding, by an MCU of the control system, a PMIC to power up the SoC, wherein the SoC is configured to execute an application after performing the bootup phase via at least one of a primary bootloader and a secondary bootloader, and wherein the PMIC is configured to control an output of a supply power to the SoC to power up or reset the SoC, monitoring, by the MCU, for a first response from the primary bootloader indicating the bootup phase was successful, commanding, by the MCU, the PMIC to reset the SoC when the first response is not received from the primary bootloader within a first timeout period, selectively requesting, by the MCU, the secondary bootloader to switch from a first partition to a second partition for the bootup phase, and after resetting, completing, by the SoC, the bootup phase using the secondary bootloader and the first or second partition.

In some implementations, the method further comprises monitoring, by the MCU, for a second response from the secondary bootloader indicating that the bootup phase was successful and requesting, by the MCU, the secondary bootloader to switch from the first partition to the second partition when the second response is not received from the secondary bootloader within a second timeout period, In some implementations, the method further comprises monitoring, by the MCU, for a third response from the application indicating that the bootup phase was successful and requesting, by the MCU, the secondary bootloader to switch from the first partition to the second partition when the third response is not received from the application within a third timeout period. In some implementations, the method further comprises setting, by the MCU, a DTC in response to a timeout of any of the first, second, and third timeout periods. In some implementations, the first timeout period is approximately 60 to 80 ms, the second timeout period is approximately 100 ms, and the third timeout period is approximately 150 ms.

In some implementations, requesting the secondary bootloader to switch from the first partition to the second partition is performed by the MCU based on an adaptive partition switch setting of a set of general purpose input/output (GPIO) output pins of the MCU. In some implementations, the primary bootloader is provided by a supplier of the SoC and is not configurable by an original equipment manufacturer (OEM) of the vehicle. In some implementations, the control system has a zonal architecture, and wherein the SoC, the PMIC, and the MCU are all part of a same zone of the zonal architecture. In some implementations, the same zone includes the SoC and one or more other SoCs that are all associated with the MCU.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of a vehicle having an example control system configured for system-on-chip (SoC) bootup failure state handling and recovery according to the principles of the present application;

FIG. 2 is a dataflow diagram of example microcontroller unit (MCU) and SoC communications during an SoC bootup phase with adaptive partitioning according to the principles of the present application; and

FIG. 3 is a flow diagram of an example method of handling errors and statuses of a bootup phase of an SoC of a control system of a vehicle according to the principles of the present application.

### DESCRIPTION

As previously discussed, today's vehicle control systems are moving towards zonal architectures, where a central microcontroller unit (MCU) is configured to oversee a plurality of different system-on-chips (SoCs) associated with a particular zone of the vehicle. Each SoC performs a bootup phase upon power up and reset, such as after software or firmware upgrades. As over-the-air (OTA) update capabilities advance, the complexity rises and improved bootup and communication between the MCU and the SoCs is required. Conventional solutions for SoC bootup failure handling, such as built-in self-tests (BISTs), watchdog timers, and interrupts, are limited to a specific set of failure states and also do not provide adequate recovery methods after an SoC bootup failure (e.g., long debugging processes). Thus, there exists an opportunity for improvement in the relevant art of embedded vehicle control systems.

One technique that provides a number of benefits to the design, development, running, and debugging of an embedded control system is known as and referred to herein as “adaptive partitioning.” Adaptive partitioning involves providing duplicate portions of software code in separate portions of a memory, thereby having a secondary partition that is capable of achieving at least a minimum desired functionality. Some of the benefits of adaptive partitioning include, for example, (i) efficient processor resource utilization (i.e., preventing overloading or over-provisioning), (ii) improved isolation and security, (iii) improved real-time performance, including mixed-criticality (i.e., prioritized tasks and allocated resources), (iv) improved flexibility and scalability, (v) improved fault/failure isolation and reliability, and (vi) improved development and maintenance. Accordingly, improved vehicle control systems and methods that utilize adaptive partitioning for SoC bootup phase status and error handling and recovery are presented herein.

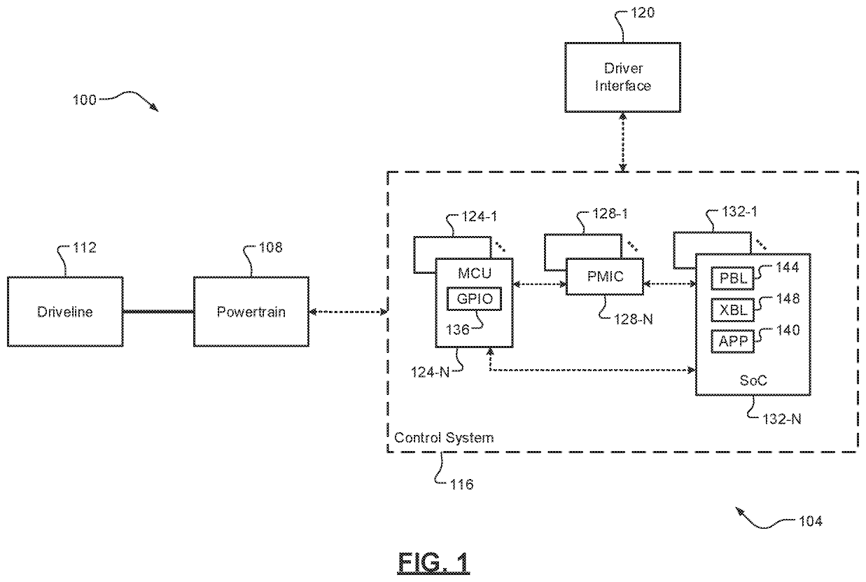

Referring now to FIG. 1, a functional block diagram of a vehicle 100 having an example control system 104 configured for SoC bootup phase failure state handling and recovery according to the principles of the present application is illustrated. The vehicle 100 generally comprises a powertrain 108 (an engine, an electric motor, some combination thereof, etc.) configured to generate and transfer torque to a driveline 112 for propulsion. The powertrain 108 is controlled by the control system 104, which primarily controls the powertrain 108 such that the powertrain 108 generates and transfers a desired amount of torque to the driveline 112 to satisfy a driver torque request. The driver torque request could be provided, for example, by a driver interface 116, which could include an accelerator pedal or another suitable device for receiving the driver torque request.

In one exemplary implementation, the control system 104 has a zonal architecture such that it defines a plurality of zones 120-1 . . . 120-N (collectively “zones 120,” where N is an integer greater than one) of the vehicle 100. Each zone 120 has a respective MCU 124-X (also referred to as “MCU 124”), power management integrated circuit (PMIC) 128-X (also referred to as “PMIC 128”), and at least one SoCs 132-X (also referred to as “SoC 132, and where X is an index from 1 to N). As previously discussed, it will be appreciated that while not explicitly shown, the SoC 132 can be a single IC that includes a processor or multiple processors/cores, memory, input/output (I/O) devices, and networking components. The MCU 124 also has a set of general purpose I/O (GPIO) pins 136 for receiving/outputting information and/or for specifying particular settings for the MCU 124 (discussed in greater detail below). It will be appreciated that each zone 120 can also include a plurality of other non-illustrated devices, such as sensors and actuators associated with that particular zone 120 of the vehicle 100.

In one exemplary implementation as shown, the SoC 132 is configured to execute an application 140 and includes both a primary bootloader (PBL) 144 and a secondary bootloader (XBL) 148 a bootup phase of the SoC and the application (APP) 140, each of which are in communication with each other as illustrated. The primary bootloader 144 could be provided, for example, by a supplier or manufacturer of the SoC 132 and thus may not be configurable by an original equipment manufacturer (OEM) of the vehicle 100. The secondary bootloader 148 and the application 140, however, may be configurable by the OEM and thus can be designed or programmed to execute at least a portion of the techniques of the present application, which will now be described in greater detail with reference to dataflow and method flow diagrams.

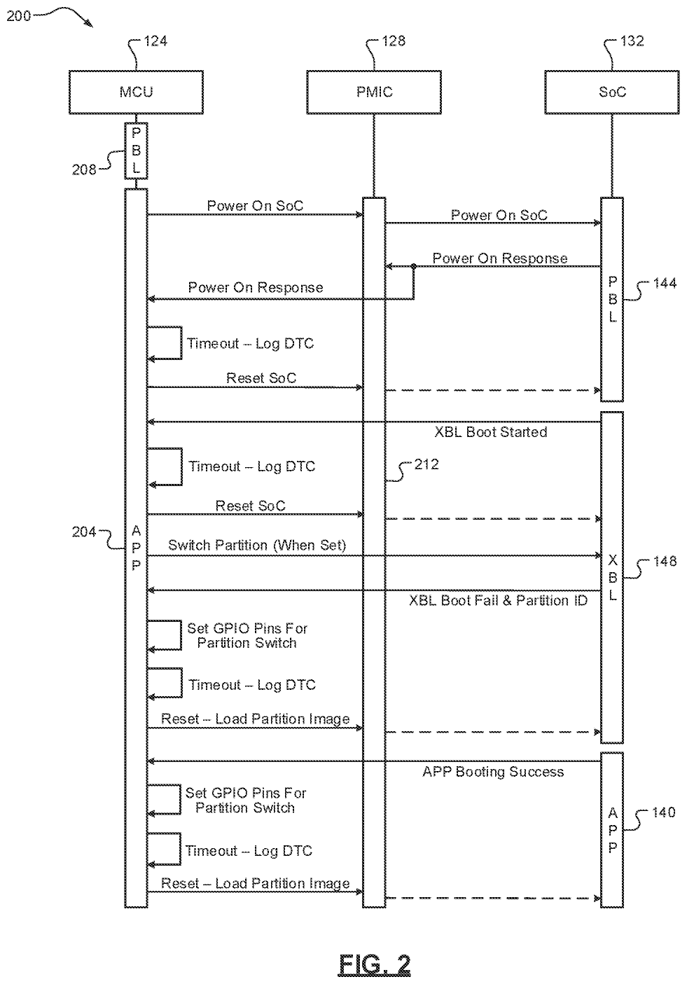

Referring now to FIG. 2, a dataflow diagram 200 of communications between the MCU 124 and the SoC 132 (including intermediary communications with the PMIC 128) during an SoC bootup phase with adaptive partitioning according to the principles of the present application is illustrated. It will be appreciated that this time-based dataflow diagram 200 is merely one example of the SoC bootup phase failure handling and recovery process of the present application and that the techniques of the present application could be represented by other dataflow diagrams. In addition, while not previously discussed, it will be appreciated that the MCU 124 is configured to power-up or startup its own software or application (APP) 204 using its own primary bootloader (PBL) 208 and the PMIC 128 is also configured to execute its own software or controls as referenced by block 212.

To begin, the MCU 124 sends a power on request or command to the PMIC 128, which in turn provides supply power to the SoC 132 to power up the SoC 132. The powering up of the SoC 132, when successful, initiates the primary bootloader (PBL) 144, which responds with a power on (e.g., maintain supply power) response to the PMIC 128 and the MCU 124. When an error or malfunction occurs and this power on response is not provided by the PBL 144 within a first timeout period (T₁), the MCU 124 detects an error and sets or logs a first diagnostic trouble code (DTC). This first timeout period could be, for example only, approximately 60-80 milliseconds (ms). It will be appreciated that the duration of this first timeout period T₁ could vary, however, depending on a design of the control system 116 and other factors.

After setting the first DTC, the MCU 124 then sends a reset eques or command to the PMIC 128. The PMIC 128 then resets the SoC 132 (e.g., via a temporary interruption in the supply power), and the SoC 132 attempts to reset or restart using the PBL 148. In a parallel process, when a bootup phase by the XBL 148 has begun, the XBL 148 sends a bootup start response back to the MCU 124. When an error or malfunction occurs and this bootup start response is not provided by the XBL 148 within a second timeout period (T₂), the MCU 124 detects an error and sets or logs a second DTC. The second timeout period could be, for example, approximately 100 ms, but it will be appreciated that this duration could vary based on other factors as previously discussed. After setting the second DTC, the MCU 124 then sends a reset request or command to the PMIC 128.

When set (described more fully below), the MCU 124 could also send a partition switch request or command to the XBL 148 of the SoC 132. If the bootup process fails, the XBL 148 could respond to the MCU 124 with a bootup failure or malfunction indication along with an indicator of the currently selected partition (e.g., Partition A or Partition B). Based on this indication, the MCU 124 could set its GPIO pins 136 to the partition switch setting as previously described. The second DTC could also be set or logged when a timeout of timeout period T₂ occurs. Finally, the MCU 124 sends a reset request or command to the PMIC 128 to reset the SoC 132 and the MCU 124, based on the GPIO settings, sends a partition switch request or command directly to the SoC 132 to load a new partition image (i.e., after the partition switch has been set). More specifically, the PMIC 128 causes the XBL 148 to reset the SoC 132 and the XBL 148 loads the other/new partition image in an attempt to successfully complete the bootup phase.

In yet another parallel process, the MCU 124 determines whether a booting success response is received from the application (APP) 140 within a third timeout period (T₃). This third timeout period could be, for example, approximately 150 ms, but it will be appreciated that this duration could vary based on other factors as previously discussed. When this booting success response is not received by the MCU 124 within the third timeout period T₃, the MCU 124 sets of logs a third DTC. The MCU 124 can also set its GPIO pins 136 to the partition switch setting. Finally, the MCU 124 sends a reset request or command to the PMIC 128 to reset the SoC 132 and the MCU 124, based on the GPIO settings, sends a partition switch request or command directly to the SoC 132 to load a new partition image (i.e., after the partition switch has been set). More specifically, the PMIC 128 causes the APP 140 to reset the SoC 132 and the APP 140 loads the other/new partition image in an attempt to successfully complete the bootup phase.

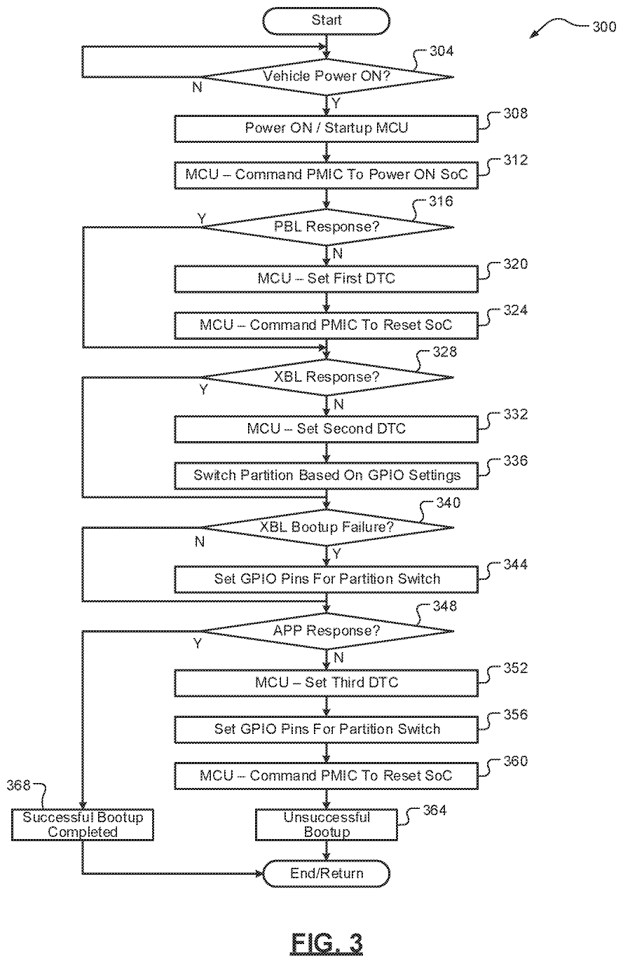

Referring now to FIG. 3, a flow diagram of an example method 300 of handling errors and statuses of a bootup phase of an SoC of a control system of a vehicle according to the principles of the present application is illustrated. While the vehicle 100 and its components (i.e., the control system 104) of FIGS. 1-2 are specifically referenced for illustrative/descriptive purposes, it will be appreciated that the method 300 could be applicable to any suitably configured vehicle or other embedded control system. The method 300 begins at 304. At 304, the control system 104 (i.e., the MCU 124) determines whether a vehicle start or power-on (e.g., ignition-on) request has been received. When false, the method 300 ends or returns to 304. When true, the method 300 proceeds to 308. At 308, the MCU 124 powers up (e.g., via its own PBL 208) and begins executing its own application or software 204. At 312, the MCU 124 commands the PMIC 128 to power up the SoC 132. At 316, the MCU 124 determines whether a first response from the primary bootloader (PBL) 144 has been received within the first timeout period T₁.

When true, the method 300 proceeds to 328. When false, the method 300 proceeds to 320 where the MCU 124 sets a first DTC. At 324, the MCU 124 commands the PMIC 128 to reset the SoC 132. At 328, the MCU 124 determines whether a second response from the secondary bootloader (XBL) 148 has been received within the second timeout period T₂. When true, the method 300 proceeds to 340. The first DTC set at 320 can also be logged and subsequently diagnosed. When false, the method 300 proceeds to 332. At 332, the MCU 124 sets a second DTC. At 336, based on the current GPIO pin 136 settings (e.g., whether to switch the current partition), the MCU 124 commands the secondary bootloader 148 of the SoC 132 to use the new/other partition.

At 340, the MCU 124 determines whether an indication of the bootup phase failure and an indication of the current SoC partition (a partition identifier or ID, e.g., partition A or partition B) has been received. When false, the method 300 proceeds to 348. When true, the method 300 proceeds to 344 where the MCU 124 sets its GPIO pins 136 to switch the partition switch setting (e.g., to switch the SoC partition from A to B). At 348, the MCU 124 determines whether a third response from the application (APP) 140 has been received within the third timeout period T₃. When true, the method 300 proceeds to 368 where a successful SoC bootup phase is achieved and the method 300 ends. When false, the method 300 proceeds to 352 where the MCU 124 sets a third DTC. At 356, the MCU 124 sets its GPIO pins 136 to the partition switch setting. At 360, the MCU 124 commands the PMIC 128 to reset the SoC 132. The method 300 could then end at 364 with an unsuccessful SoC bootup phase. The third DTC can also be logged and subsequently diagnosed along with the other malfunctions preventing startup of the vehicle 100.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A control system for a vehicle, the control system comprising:
a system-on-chip (SoC) configured to execute an application after performing a bootup phase via at least one of a primary bootloader and a secondary bootloader;
a power management integrated circuit (PMIC) configured to, in response to a command, control an output of a supply power to the SoC to power up or reset the SoC; and
a microcontroller unit (MCU) configured to provide the command to the PMIC to power up or reset the SoC and to handle errors and statuses of the SoC bootup phase by:
commanding the PMIC to power up the SoC;
monitoring for a first response from the primary bootloader indicating the bootup phase was successful;
commanding the PMIC to reset the SoC when the first response is not received from the primary bootloader within a first timeout period;
selectively requesting the secondary bootloader to switch from a first partition to a second partition for the bootup phase; and
after resetting the SoC, completing the bootup phase using the secondary bootloader and the first or second partition.

2. The control system of claim 1, wherein the MCU is further configured to handle the errors and statuses of the SoC bootup phase by:
monitoring for a second response from the secondary bootloader indicating that the bootup phase was successful; and
requesting the secondary bootloader to switch from the first partition to the second partition when the second response is not received from the secondary bootloader within a second timeout period.

3. The control system of claim 2, wherein the MCU is further configured to handle the errors and statuses of the SoC bootup phase by:
monitoring for a third response from the application indicating that the bootup phase was successful; and
requesting the secondary bootloader to switch from the first partition to the second partition when the third response is not received from the application within a third timeout period.

4. The control system of claim 3, wherein the MCU is further configured to handle the errors and statuses of the SoC bootup phase by setting a diagnostic trouble code (DTC) in response to a timeout of any of the first, second, and third timeout periods.

5. The control system of claim 4, wherein the first timeout period is approximately 60 to 80 milliseconds (ms), the second timeout period is approximately 100 ms, and the third timeout period is approximately 150 ms.

6. The control system of claim 1, wherein the MCU is configured to request the secondary bootloader to switch from the first partition to the second partition based on an adaptive partition switch setting of a set of general purpose input/output (GPIO) output pins of the MCU.

7. The control system of claim 1, wherein the primary bootloader is provided by a supplier of the SoC and is not configurable by an original equipment manufacturer (OEM) of the vehicle.

8. The control system of claim 1, wherein the control system has a zonal architecture, and wherein the SoC, the PMIC, and the MCU are all part of a same zone of the zonal architecture.

9. The control system of claim 8, wherein the same zone includes the SoC and one or more other SoCs that are all associated with the MCU.

10. A method of handling errors and statuses of a bootup phase of a system-on-chip (SoC) of a control system of a vehicle, the method comprising:
commanding, by a microcontroller unit (MCU) of the control system, a power management integrated circuit (PMIC) to power up the SoC, wherein the SoC is configured to execute an application after performing the bootup phase via at least one of a primary bootloader and a secondary bootloader, and wherein the PMIC is configured to control an output of a supply power to the SoC to power up or reset the SoC;
monitoring, by the MCU, for a first response from the primary bootloader indicating the bootup phase was successful;
commanding, by the MCU, the PMIC to reset the SoC when the first response is not received from the primary bootloader within a first timeout period;
selectively requesting, by the MCU, the secondary bootloader to switch from a first partition to a second partition for the bootup phase; and
after resetting, completing, by the SoC, the bootup phase using the secondary bootloader and the first or second partition.

11. The method of claim 10, further comprising:
monitoring, by the MCU, for a second response from the secondary bootloader indicating that the bootup phase was successful; and
requesting, by the MCU, the secondary bootloader to switch from the first partition to the second partition when the second response is not received from the secondary bootloader within a second timeout period.

12. The method of claim 11, further comprising:
monitoring, by the MCU, for a third response from the application indicating that the bootup phase was successful; and
requesting, by the MCU, the secondary bootloader to switch from the first partition to the second partition when the third response is not received from the application within a third timeout period.

13. The method of claim 12, further comprising setting, by the MCU, a diagnostic trouble code (DTC) in response to a timeout of any of the first, second, and third timeout periods.

14. The method of claim 13, wherein the first timeout period is approximately 60 to 80 milliseconds (ms), the second timeout period is approximately 100 ms, and the third timeout period is approximately 150 ms.

15. The method of claim 10, wherein requesting the secondary bootloader to switch from the first partition to the second partition is performed by the MCU based on an adaptive partition switch setting of a set of general purpose input/output (GPIO) output pins of the MCU.

16. The method of claim 10, wherein the primary bootloader is provided by a supplier of the SoC and is not configurable by an original equipment manufacturer (OEM) of the vehicle.

17. The method of claim 10, wherein the control system has a zonal architecture, and wherein the SoC, the PMIC, and the MCU are all part of a same zone of the zonal architecture.

18. The method of claim 17, wherein the same zone includes the SoC and one or more other SoCs that are all associated with the MCU.
